(19) United States
(12) Patent Application Publication
(10) Pub. No.: US 2015/0266338 A1
(43) Pub. Date: Sep. 24, 2015

(54) ALUMINIUM WHEEL FOR VEHICLE AND THE MANUFACTURING METHOD

(71) Applicant: HYUNDAI MOTOR COMPANY, Seoul (KR)

(72) Inventors: MinSoo KIM, Seoul (KR); Kwang Min YOON, Suwon-si (KR); Young Chan KIM, Hwaseong-si (KR)

(21) Appl. No.: 14/522,549

(22) Filed: Oct. 23, 2014

(30) Foreign Application Priority Data
Mar. 18, 2014 (KR) 10-2014-0031680

(51) Int. Cl. B60B 3/12; B22D 21/00; B60B 3/06; C04B 35/622; B60B 3/10; B60B 3/02; B22D 18/04; B22D 19/00

(52) U.S. Cl. CPC B60B 3/12; B22D 18/04; B22D 21/007; B22D 19/00; C04B 35/622; B60B 3/10; B60B 3/02; B60B 3/06; B60B 2900/111; B60B 2900/311; B60B 2310/202; B60B 2310/232; B60B 2360/70; B60B 2360/104; B60B 2360/147

(57) ABSTRACT

A method of manufacturing an aluminum wheel for a vehicle includes preparing a low density material having particles pulverized. A binder is supplied to the low density material so that the low density material is mixed in a paste state. A wheel core manufacturing mold is heated to 200 to 350° C. and injected into the wheel core manufacturing mold. The wheel core manufacturing mold is closed, a pressure of about 5 to 20 bar is applied, the pressure is maintained for 1 to 5 minutes to solidify the low density material, and the wheel core is ejected. The ejected wheel core is mounted on an aluminum wheel casting mold. The aluminum wheel casting mold is closed, and a pressure of about 1 to 2 bar is applied, and an aluminum molten metal is injected. The aluminum wheel is then ejected from the aluminum wheel casting mold.

### CROSS-REFERENCE TO RELATED APPLICATION

This application claims the benefit of priority to Korean Patent Application No. 10-2014-0031680 filed in the Korean Intellectual Property Office on Mar. 18, 2014, the entire contents of which are incorporated herein by reference.

### TECHNICAL FIELD

The present disclosure relates to an aluminum wheel for a vehicle and a method of manufacturing the same, and more particularly, to an ultra-light high stiffness aluminum wheel for a vehicle, in which wheel stiffness can be increased and weight is decreased, and a method of manufacturing the same.

### BACKGROUND

A vehicle wheel may be broadly classified into a steel wheel and an aluminum wheel. Among them, the aluminum wheel has been largely manufactured due to implementation of various colors and shapes and a weight reduction effect as compared to the steel wheel, and thus, the aluminum wheel is applied to various types of vehicles for mass production.

Particularly, the aluminum wheel has an important effect of improving riding comfort, control performance, and steering performance of a vehicle by reducing the overall weight due to an un-sprung mass reduction effect of vehicle suspension parts and the like.

Current vehicles largely reflect noise, vibration, and harshness (NVH) characteristics to satisfy the customer demands. Accordingly, various technologies have been developed to reduce noise of the wheel by increasing the vehicle stiffness. However, when the wheel stiffness is increased, the overall weight is also increased while maintaining the aesthetic part of the vehicle. As the weight is increased, riding comfort and controllability may become rather poor.

As described above, the use of the aluminum wheel may improve fuel efficiency and riding comfort and controllability while reducing noise.

In the case of the aluminum wheel, a weight reduction can be achieved by changing a material or by applying a high hardness process. As compared to a low pressure die casting aluminum wheel of the related art, when aluminum forging materials and the high hardness process are applied to the wheel, the weight may be reduced by about 10%, but the manufacturing cost is increased to high cost by about 3 to 5 times or more as compared to the low pressure die casting aluminum wheel, and thus, the use of the aluminum forging and hardened materials are limited.

In the case in which the weight is reduced by about 10%, since the wheel stiffness is also reduced, a problem of road noise deterioration and the like may occur, and further, a method of significantly reducing the weight has not yet been developed.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide an ultra-light high stiffness aluminum wheel for a vehicle, in which wheel stiffness can be increased and the weight can be reduced while maintaining a design of the aluminum wheel by inserting a wheel core having an ultra-low density as compared to aluminum into an interior thick portion (mainly, flange portion) of the aluminum wheel, and a method of manufacturing the same.

According to an exemplary embodiment of the present invention, a method of manufacturing an aluminum wheel for a vehicle includes a low density material preparing step of preparing a low density material having particles pulverized to have a predetermined particle size and a density that is lower than a density of aluminum. A binder mixing step supplies a binder to the low density material to perform mixing so that the low density material is mixed in a paste state. A low density material injecting step heats a wheel core manufacturing mold to 200 to 350° C. and then the low density material mixed with the binder is injected into the wheel core manufacturing mold. A wheel core ejecting step closes the wheel core manufacturing mold, applies a pressure of about 5 to 20 bar, maintains the pressure for 1 to 5 minutes to completely solidify the low density material, and ejects the manufactured wheel core from the wheel core manufacturing mold. A wheel core mounting step mounts the wheel core ejected in the wheel core ejecting step in an aluminum wheel casting mold.

An aluminum molten metal injecting step of closes the aluminum wheel casting mold, applies a pressure of about 1 to 2 bar in a low pressure die casting machine, and then injects an aluminum molten metal. An aluminum wheel ejecting step ejects the aluminum wheel manufactured by finishing coagulation of the aluminum molten metal from the aluminum wheel casting mold.

The wheel core mounting step may include a machining step of machining the aluminum wheel casting mold for mounting an aluminum rod on the wheel core. An aluminum rod mounting step mounts the aluminum rod on the machined portion of the wheel core. A wheel core inserting step inserts the wheel core in which the aluminum rod is mounted on the aluminum wheel casting mold.

The low density material may be formed of an expanded vermiculite having a density of 0.2 to 0.5 g/cm³ and a particle size of about 0.5 to 2.5 mm.

The binder may be formed of a water glass so that the expanded vermiculite is well mixed in the paste state.

The water glass may be mixed at a volume ratio of 2 to 7% based on the expanded vermiculite with the expanded vermiculite through a spray form.

The machining step may include forming at least one or more mounting holes for mounting the aluminum rod on the wheel core.

According to another exemplary embodiment of the present invention, an aluminum wheel for vehicles manufactured according to the method of manufacturing the aluminum wheel for vehicles includes a flange portion and a spoke portion provided on a front surface and a rim portion on which a tire is mounted. A wheel core is disposed in the flange portion and made of a low density material having a density that is lower than a density of a material of the aluminum wheel for vehicles so that a reduction in weight of the aluminum wheel for vehicles is implemented and wheel stiffness is increased.

A hollow portion where an interior portion is hollow to insert and mount the wheel core may be formed in the flange portion.

The wheel core may include an edge portion comprising an outskirt edge, and the spoke portion protrudes toward the center of the wheel core and disposed at a predetermined interval on an interior circumference of the edge portion.

An aluminum rod for being mounted in an aluminum wheel casting mold may be mounted at the edge portion.

A mounting hole for mounting the aluminum rod may be formed at the edge portion.

According to the exemplary embodiments of the present invention, by inserting a wheel core into an aluminum wheel for vehicles to manufacture the aluminum wheel for vehicles, it is possible to significantly reduce the weight of the aluminum wheel and increase stiffness of the aluminum wheel while a design of the aluminum wheel for a vehicle is maintained as it is like the related art. Particularly, the weight is reduced by, for example, 5 kg/aluminum wheel and NVH characteristics are improved as compared to the aluminum wheel for a vehicle having the same design in the related art, and it is possible to implement dynamic stiffness with 5% improvement.

### BRIEF DESCRIPTION OF THE DRAWINGS

FIG. 1 is a schematic diagram of a method of manufacturing an aluminum wheel for a vehicle according to an exemplary embodiment of the present invention.

FIG. 2 is a partially cut perspective view illustrating an aluminum wheel for a vehicle manufactured by the method of manufacturing the aluminum wheel for a vehicle according to the exemplary embodiment of the present invention.

FIG. 3 is a partial cross-sectional view illustrating the aluminum wheel for a vehicle manufactured by the method of manufacturing the aluminum wheel for a vehicle according to the exemplary embodiment of the present invention.

FIG. 4 is a perspective view illustrating a wheel core manufactured by the method of manufacturing the aluminum wheel for a vehicle according to the exemplary embodiment of the present invention.

FIG. 5 is a partial perspective view illustrating a state where an aluminum rod is mounted on the wheel core used in the method of manufacturing the aluminum wheel for a vehicle according to the exemplary embodiment of the present invention.

### DETAILED DESCRIPTION OF THE EMBODIMENTS

The present disclosure will be described more fully hereinafter with reference to the accompanying drawings, in which exemplary embodiments of the invention are shown so as to be easily understood by the person with ordinary skill in the art. As easily understood by the person with ordinary skill in the art to which the present disclosure pertains, the exemplary embodiments which will be described below may be variously modified without departing from the spirit and the scope of the present disclosure. If possible, the same or similar portions are represented by using the same reference numeral in the drawings.

The terminologies used hereinafter are set forth just to illustrate a specific exemplary embodiment but not to limit the present invention. It must be noted that, as used in the specification and the appended claims, the singular forms include plural references unless the context clearly dictates otherwise. It will be further understood that the terms “comprises,” when used in this specification, specify the presence of stated properties, regions, integers, steps, operations, elements, and/or components, but do not preclude the presence or addition of one or more other properties, regions, integers, steps, operations, elements, components, and/or groups.

All terms including technical terms and scientific terms used herein have the same meaning as the meaning generally understood by the person with ordinary skill in the art to which the present invention pertains. The terminologies that are defined previously are further understood to have the meaning that coincides with relating technical documents and the contents that are disclosed currently, but not interpreted as the ideal or very official meaning unless it is defined.

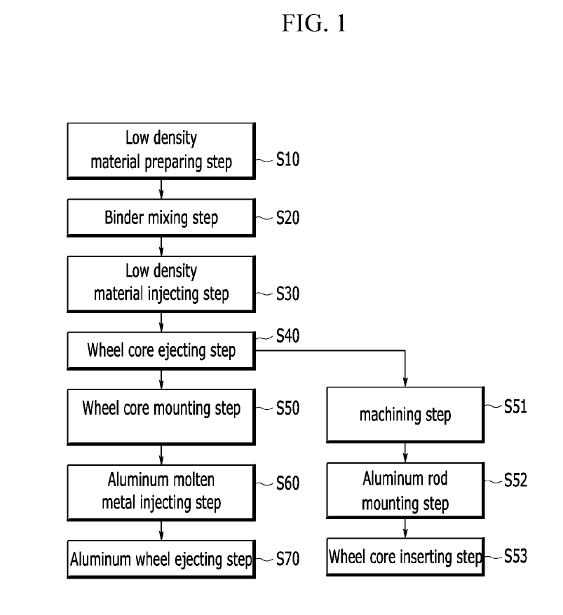

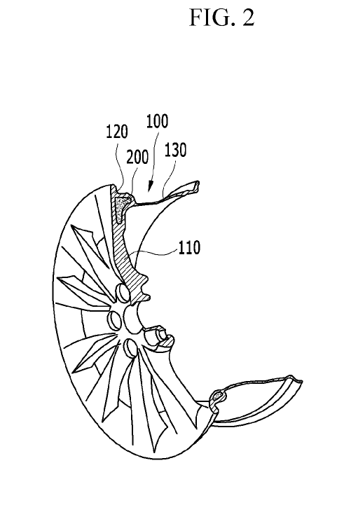

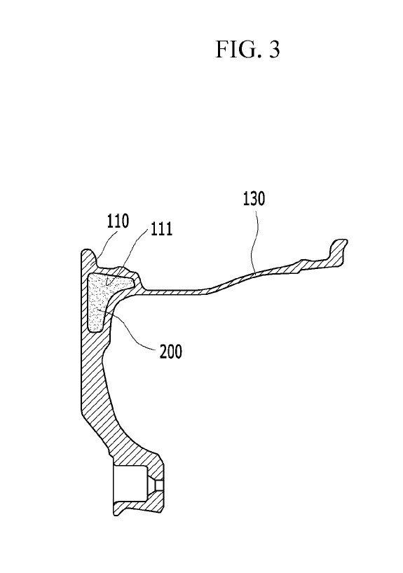

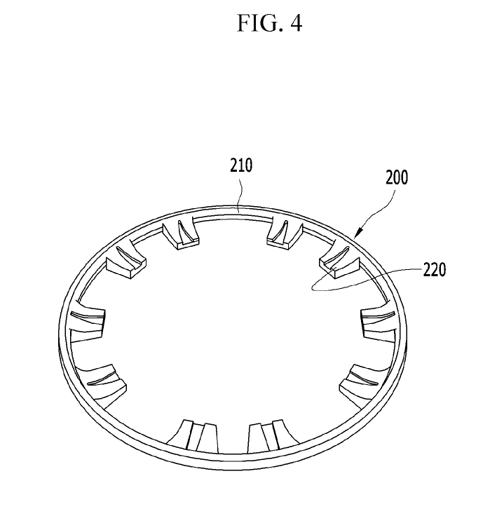

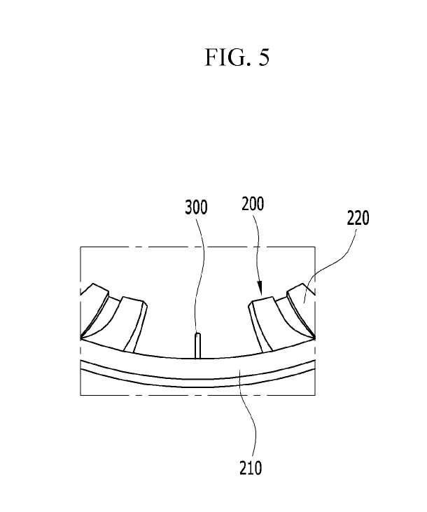

FIG. 1 is a schematic diagram of a method of manufacturing an aluminum wheel for a vehicle according to an exemplary embodiment of the present invention. FIG. 2 is a partially cut perspective view illustrating an aluminum wheel for a vehicle manufactured by the method of manufacturing the aluminum wheel for a vehicle according to the exemplary embodiment of the present invention. FIG. 3 is a partial cross-sectional view illustrating the aluminum wheel for a vehicle manufactured by the method of manufacturing the aluminum wheel for a vehicle according to the exemplary embodiment of the present invention. FIG. 4 is a perspective view illustrating a wheel core manufactured by the method of manufacturing the aluminum wheel for a vehicle according to the exemplary embodiment of the present invention. FIG. 5 is a partial perspective view illustrating a state where an aluminum rod is mounted on the wheel core used in the method of manufacturing the aluminum wheel for a vehicle according to the exemplary embodiment of the present invention.

The method of manufacturing the aluminum wheel for a vehicle according to the exemplary embodiment of the present invention is a method of increasing wheel stiffness while a reduction in weight is implemented as compared to an aluminum wheel for a vehicle while maintaining the design of related art.

Referring to FIGS. 1 to 5, the method of manufacturing the aluminum wheel for a vehicle according to an exemplary embodiment of the present invention may include preparing a low density material having particles pulverized to have a predetermined particle size and a density that is lower than a density of aluminum (S10). Then, a binder is supplied to the low density material to perform mixing so that the low density material is mixed in a paste state (S20).

A mold for manufacturing a wheel core is heated to 200 to 350° C., and then the low density material mixed with the binder is injected into the aluminum wheel core manufacturing mold (S30). The wheel core manufacturing mold is closed, a pressure of about 5 to 20 bar is applied, the pressure for 1 to 5 minutes is maintained to completely solidify the low density material, and the manufactured wheel core 200 is ejected from the wheel core manufacturing mold (S40).

The wheel core 200 ejected in step S40 is mounted into an aluminum wheel casting mold (S50). The aluminum wheel casting mold is closed, and a pressure of about 1-2 bar is applied in a low pressure die casting machine, and then an aluminum molten metal is injected (S60). The aluminum wheel 100, which is manufactured after the aluminum molten metal is solidified, is ejected from the aluminum wheel casting mold (S70).

The wheel core mounting step S50 may further include a machining step of machining the aluminum wheel casting mold for mounting an aluminum rod 300 on the wheel core 200 (S51). The aluminum rod 300 is mounted on the machined portion of the wheel core 200 (S52). The wheel core 200 is inserted in which the aluminum rod 300 is provided into the aluminum wheel casting mold (S53).

The machining step S51 may include forming at least one or more mounting holes (not illustrated) for mounting the aluminum rod 300 on the wheel core 200.

The low density material may be formed of an expanded vermiculite having a density of 0.2 to 0.5 g/cm³ and a particle size of about 0.5 to 2.5 mm.

In the case where the density of the expanded vermiculite is 0.6 or more, since a great weight reduction cannot be achieved due to a high total density after mixing and coagulation of a water glass, the density of the expanded vermiculite may be 0.5 g/cm³ or less, or 0.2 to 0.5 g/cm³.

The binder may not generate a gas in the aluminum molten metal and may have heat resistance that can endure the aluminum molten metal. Further, the binder may have no reactivity with aluminum, and may be formed of the water glass (Na₂O 8-10%+SiO₂ 28-30%+H₂O 60-64%) so that the expanded vermiculite is well mixed in a paste state.

Since the content of the water glass (Na₂O 8-10%+SiO₂ 28-30%+H₂O 60-64%) has a relationship with the density of the wheel core, only an appropriate amount of the water glass needs to be mixed based on the expanded vermiculite, and the water glass may be mixed at a volume ratio of 2 to 7% based on the expanded vermiculite with the expanded vermiculite through a spray form.

The aluminum rod 300 is for mounting the wheel core 200 in the aluminum wheel casting mold and may have a diameter of 2 to 3 mm. The mounting hole may have a diameter that is smaller than a diameter of the aluminum rod 300, for example, a diameter of 1 to 2 mm, so that the aluminum rod 300 can be pressed and inserted.

The method of manufacturing the aluminum wheel for a vehicle according to the exemplary embodiment of the present invention will be described below in more detail.

First, a wheel core to be inserted into which stiffness and hardness of the wheel is not affected in the aluminum wheel for a vehicle is designed, and a mold for manufacturing the designed wheel core is manufactured.

The low density material having pulverized particles to have a predetermined particle size and the density that is lower than the density of aluminum, for example, the expanded vermiculite having the particle size of about 0.5 to 2.5 mm and the density of 0.2 to 0.5 g/cm³ is prepared at S10, and the binder, for example, the water glass (Na₂O 8-10%+SiO₂ 28-30%+H₂O 60-64%) is supplied to and mixed with the low density material so that the expanded material is mixed in the paste state at step S20.

After the wheel core manufacturing mold is heated to about 200 to 350° C., the expanded vermiculite mixed with the water glass is injected into the wheel core manufacturing mold at S30, and the wheel core manufacturing mold is closed. A pressure of about 5 to 20 bar is applied and maintained for 1 to 5 minutes to completely solidify the expanded material mixed with the water glass, and the manufactured wheel core 200 is ejected from the wheel core manufacturing mold at step S40.

The ejected wheel core 200 in the wheel core ejecting step is mounted in the aluminum wheel casting mold for casting at step S50. That is, machining the aluminum wheel casting mold for mounting the aluminum rod 300 on the wheel core 200 is performed S51, the aluminum rod 300 is mounted on which the stiffness and hardness of the wheel are not affected in the machined portion of the wheel core 200 at step S52, and the wheel core 200 in which the aluminum rod 300 is mounted is inserted into the aluminum wheel casting mold at step S53.

After the aluminum wheel casting mold is closed, a pressure of about 1 to 2 bar is applied to inject the aluminum molten metal in the low pressure die casting machine at step S60, and the aluminum wheel 100 manufactured by finishing solidification of the aluminum molten metal is ejected from the aluminum wheel casting mold at step S70.

By inserting the wheel core having the ultra-low density as compared to aluminum into the aluminum wheel for a vehicle to manufacture the aluminum wheel, it is possible to maximize the reduction in weight of the aluminum wheel and maximally increase stiffness of the aluminum wheel while a design of the aluminum wheel for vehicles is maintained. Particularly, the weight is reduced, for example, 5 kg/aluminum wheel, noise, vibration, and harshness (NVH) characteristics are improved, and dynamic stiffness of the vehicle is improved by 5%.

The aluminum wheel 100 for a vehicle manufactured according to the exemplary embodiment of the present invention may include a flange portion 110 and a spoke portion 120 provided on a front surface of the wheel 100 and a rim portion 130 in which a tire (not illustrated) is mounted on. The wheel core 200 is disposed inside the flange portion 110 and made of a low density material having a density that is lower than that the aluminum wheel 100 to reduce the weight while increasing wheel stiffness.

A hollow portion 111 into which the wheel core 200 is inserted may be formed in the flange portion 110. The wheel core 200 may include an edge portion 210 constituting an outskirt edge and a spoke portion 220 inwardly protruding toward the center of the wheel core 200 and disposed at a predetermined interval on an inner circumference of the edge portion 210.

The aluminum rod 300 for being mounted in the aluminum wheel casting mold (not illustrated) for a vehicle may be mounted at the edge portion 210, and a mounting hole (not illustrated) for mounting the aluminum rod 300 may be formed at the edge portion 210.

Further, the aluminum rod 300 is for mounting the wheel core 200 in the aluminum wheel casting mold, and may have a diameter of 2 to 3 mm.

The mounting hole may have a diameter smaller than that of the aluminum rod 300, for example, a diameter of 1 to 2 mm, so that the aluminum rod 300 can be pressed and inserted into the mounting hole.

As described above, by inserting and mounting the wheel core 200 of the low density material in the hollow portion 111 formed in the flange portion 110 of the aluminum wheel 100, it is possible to significantly reduce the weight of the aluminum wheel and increase stiffness of the aluminum wheel while maintain a design of the aluminum wheel as the related art. Particularly, the weight of the aluminum wheel can be reduced, for example, 5 kg, NVH characteristics can be improved, and dynamic stiffness 5% can be improved.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A method of manufacturing an aluminum wheel for a vehicle, comprising:
a low density material preparing step of preparing a low density material of pulverized particles having a predetermined particle size and a density that is lower than a density of aluminum;
a binder mixing step of supplying a binder to the low density material and mixing them in a paste state;
a low density material injecting step of heating a wheel core manufacturing mold to 200 to 350° C. and then injecting the low density material mixed with the binder into the wheel core manufacturing mold;
a wheel core ejecting step of closing the wheel core manufacturing mold, applying a pressure of about 5 to 20 bar, maintaining the pressure for 1 to 5 minutes to completely solidify the low density material, and ejecting the manufactured wheel core from the wheel core manufacturing mold; and
a wheel core mounting step of mounting the wheel core ejected in the wheel core ejecting step into an aluminum wheel casting mold.

2. The method of claim 1, further comprising:
an aluminum molten metal injecting step of closing the aluminum wheel casting mold, and applying a pressure of about 1 to 2 bar in a low pressure die casting machine and then injecting an aluminum molten metal; and
an aluminum wheel ejecting step of ejecting the aluminum wheel after the aluminum molten metal is solidified from the aluminum wheel casting mold.

3. The method of claim 1, wherein:
the wheel core mounting step includes a machining step of machining the aluminum wheel casting mold for mounting an aluminum rod on the wheel core,
an aluminum rod mounting step of mounting the aluminum rod on a machined portion of the wheel core, and
a wheel core inserting step of inserting the wheel core on which the aluminum rod is mounted into the aluminum wheel casting mold.

4. The method of claim 1, wherein:
the low density material is formed of an expanded vermiculite having a density of 0.2 to 0.5 g/cm³ and a particle size of about 0.5 to 2.5 mm.

5. The method of claim 1, wherein:
the binder is formed of a water glass so that the expanded vermiculite is well mixed in the paste state.

6. The method of claim 5, wherein:
the water glass is mixed at a volume ratio of 2 to 7% based on the expanded vermiculite with the expanded vermiculite through a spray form.

7. The method of claim 3, wherein:
the machining step includes forming at least one or more mounting holes for mounting the aluminum rod in the wheel core.

8. An aluminum wheel for a vehicle manufactured according to the method of manufacturing the aluminum wheel for vehicles according to claim 1, comprising:
a flange portion and a spoke portion provided on a front surface,
a rim portion on which a tire is mounted, and
a wheel core disposed inside the flange portion and made of a low density material having a density that is lower than that of aluminum for the aluminum wheel so that a reduction in weight of the aluminum wheel is implemented and wheel stiffness is increased.

9. The aluminum wheel for vehicles of claim 8, wherein:
a hollow portion into which the wheel core is disposed is formed in the flange portion.

10. The aluminum wheel for vehicles of claim 8, wherein:
the wheel core includes an edge portion having an outskirt edge thereon, and
the spoke portion protruding toward the center of the wheel core and disposed at a predetermined interval on the inner circumference of the edge portion.

11. The aluminum wheel for vehicles of claim 10, wherein:
an aluminum rod in an aluminum wheel casting mold is mounted at the edge portion.

12. The aluminum wheel for vehicles of claim 11, wherein:
a mounting hole for mounting the aluminum rod is formed on the edge portion.

13. The method of claim 3, wherein the machining includes a milling process.
